(19) United States
(12) Patent Application Publication
(10) Pub. No.: US 2026/0356516 A1
(43) Pub. Date: Nov. 12, 2026

(54) URBAN DRONE TAKEOFF, LANDING, AND PARKING SYSTEM

(71) Applicants: Seong In JUNG, Namyangju-si, Gyeonggi-do (KR); DESIGN GROUP E-RU ARCHITECTS CO., LTD., Seoul (KR); CARCRAB CO., LTD., Yongin-si, Gyeonggi-do (KR)

(72) Inventor: Seong In JUNG, Namyangju-si, Gyeonggi-do (KR)

(73) Assignees: Seong In JUNG, Namyangju-si, Gyeonggi-do (KR); DESIGN GROUP E-RU ARCHITECTS CO., LTD., Seoul (KR); CARCRAB CO., LTD., Yongin-si, Gyeonggi-do (KR)

(21) Appl. No.: 19/488,633

(22) PCT Filed: May 31, 2024
(86) PCT No.: PCT/KR2024/007493

§ 371 Date: Nov. 28, 2025

(30) Foreign Application Priority Data
Jun. 1, 2023 (KR) 10-2023-0070918

(51) Int. Cl. B64U 80/10; B64C 27/20; B64F 1/222; B64U 10/14; B64U 70/90; B64U 80/40; B66B 9/00; B66B 11/00; E04H 6/18; E04H 6/44; G08G 5/32

(52) U.S. Cl. CPC B64U 80/10; B64C 27/20; B64F 1/222; B64U 10/14; B64U 70/90; B64U 80/40; B66B 9/00; B66B 11/004; E04H 6/18; E04H 6/44; G08G 5/32

(57) ABSTRACT

The present invention relates to an urban drone landing, take-off, and parking system, and more specifically, to a system in which drone landing, take-off facilities, and parking spaces are formed in the upper floors of a building, wherein the take-off and landing areas are separated to ensure safety during operations, and parking spaces are formed between the take-off and landing areas, providing a convenient and safe urban drone operation system.

### FIELD

The present invention relates to an urban drone takeoff, landing, and parking system, and more particularly, to a system in which a drone takeoff facility and parking space are formed on an upper portion of a building, wherein a takeoff space and a landing space are separately configured for safety during takeoff and landing, and a parking space is formed between the takeoff space and the landing space.

### BACKGROUND ART

Drones are emerging as next-generation transportation means in the era of the Fourth Industrial Revolution, and research and development are actively being conducted not only on unmanned drones without passengers but also on manned drones capable of carrying people.

However, in order for drones to be utilized for delivery, logistics, and transportation convenience, infrastructure that allows drones to freely take off, land, and park is urgently needed.

Due to the flight characteristics of drones, no obstacles must be present for safe landing, and therefore, a landing pad must be a space free from high-rising obstructions.

In urban areas, land space for drone landing is limited, so it is desirable to utilize rooftop levels where interference from obstacles is relatively low.

However, rooftop areas have limited space, and when takeoff and landing occur simultaneously, spatial constraints may cause safety hazards, which has been a problem.

### DISCLOSURE

### Technical Problem

The present invention has been devised to solve the aforementioned problems, and an object of the present invention is to provide an urban drone takeoff, landing, and parking system in which a landing unit for drone landing is installed on the rooftop level, a take-off unit is separately installed on an intermediate floor to minimize interference between takeoff and landing operations and prevent safety accidents in advance, and a hangar unit capable of parking multiple drones is formed across multiple floors between the landing unit and the take-off unit, thereby enhancing both takeoff/landing safety and parking convenience within urban environments.

### Technical Solution

To achieve the above-described objectives, the urban drone takeoff, landing, and parking system according to the present invention is a system formed in an upper exclusive space of a building, comprising: a landing unit formed on the rooftop level; a take-off unit formed on an intermediate floor below and adjacent to the landing unit; a vertical movement means for vertically moving between the landing unit and the take-off unit to raise and lower drones; a hangar unit formed on at least one floor between the landing unit and the take-off unit to park and manage drones; a horizontal movement means for horizontally moving drones between the landing unit and the vertical movement means, and between the hangar unit and the vertical movement means; and a control unit configured to control operations of the vertical movement means and the horizontal movement means.

Further, And the vertical movement means is configured to ensure safety during drone landing, and comprises an elevator unit that moves only up to the top floor due to a machine room located above the elevator unit, and a lift unit that, after a horizontal transfer from the elevator unit, moves from the top floor to the rooftop level. Since the lift unit has its machine room located below, this configuration ensures that the rooftop vertiport (landing unit) is formed at a height higher than the machine room, and the machine room does not protrude above the rooftop, thereby preventing in advance any safety hazard that may otherwise occur if the machine room were to act as an obstacle during drone landing.

The landing unit is formed on the rooftop floor, the takeoff unit is formed on an intermediate floor vertically below and adjacent to one side of the landing unit, a lift unit of the vertical movement means is formed on the other side adjacent to the landing unit, and an elevator unit is formed below the landing unit.

In this case, the horizontal movement means horizontally moves drones between the landing unit and the elevator unit, between the elevator unit and the hangar unit, between the elevator unit and the lift unit, and between the lift unit and the take-off unit. The horizontal movement means may include a fixed movement type in which rails, conveyor belts, or similar mechanisms are installed on the floor or side surfaces, or an autonomous movement type using wheels.

Furthermore, the vertical movement means raises and lowers drones while vertically moving between the landing unit and the take-off unit, and is implemented as a lift unit with a machine room provided on the lower portion. The lift unit is formed so as not to protrude above the vertiport of the rooftop level and is aligned with the floor level of the landing unit.

In this case, the horizontal movement means horizontally moves drones between the landing unit and the lift unit, between the lift unit and the hangar unit, and between the lift unit and the take-off unit. The horizontal movement means may include a fixed movement type in which rails, conveyor belts, or similar mechanisms are fixedly installed on the floor or side walls, or an autonomous movement type equipped with wheels.

The control unit includes a control module for controlling drone takeoff and landing; a movement schedule management module for allocating a hangar unit for drones that have landed on the landing unit, determining a movement schedule for parking them, and determining the movement schedule for drones requesting takeoff; and a movement control module for controlling vertical or horizontal movement to transfer a drone that has landed on the landing unit to the hangar unit, or to transfer a drone parked in the hangar unit to the take-off unit according to the determined movement schedule.

### Advantageous Effects

According to the present invention, an urban drone takeoff, landing, and parking system is provided in an upper space of an urban building, thereby offering takeoff, landing, and parking spaces suitable for complex urban environments.

In particular, a landing unit is installed on the rooftop floor, and a take-off unit is separately installed on an intermediate floor to minimize interference between takeoff and landing operations, thereby preventing safety accidents in advance. Additionally, a hangar unit capable of parking multiple drones is formed across multiple floors between the landing unit and the take-off unit, resulting in excellent effects of enhancing both takeoff/landing safety and parking convenience in an urban environment.

### DESCRIPTION OF DRAWINGS

FIG. 1 is a configuration diagram of an urban drone takeoff, landing, and parking system according to a preferred embodiment of the present invention.

FIGS. 2 to 4 are cross-sectional views of FIG. 1.

FIGS. 5 to 7 are plan views of the urban drone takeoff, landing, and parking system according to a preferred embodiment of the present invention.

FIG. 8 schematically illustrates a conveyor belt drive module formed on the floor of the elevator unit and the floor of the hangar unit according to a preferred embodiment of the present invention.

FIGS. 9 and 10 illustrate two conveyor belts configured as a single pair.

FIGS. 11 and 12 schematically illustrate horizontal movement of drones by the autonomous movement type of the horizontal movement means according to a preferred embodiment of the present invention.

FIG. 13 is a block diagram schematically illustrating the urban drone takeoff, landing, and parking system according to a preferred embodiment of the present invention.

FIGS. 14 and 15 schematically illustrate movement of drones by the conveyor belt type.

FIG. 16 schematically illustrates a landed drone moving to an assigned hangar.

FIGS. 17 and 18 are cross-sectional views of an urban drone takeoff, landing, and parking system according to another embodiment of the present invention.

FIGS. 19 to 21 are plan views of the urban drone takeoff, landing, and parking system according to a preferred embodiment of the present invention. FIG. 19 is a plan view of the rooftop level where the landing unit is located, FIG. 20 is a plan view of the floor where the hangar unit is located, and FIG. 21 is a plan view of the intermediate floor where the take-off unit is located.

FIG. 22 schematically illustrates a conveyor belt drive module formed on the floor of the lift unit and the floor of the hangar unit according to a preferred embodiment of the present invention.

FIG. 23 is a block diagram schematically illustrating the urban drone takeoff, landing, and parking system according to a preferred embodiment of the present invention.

FIGS. 24 and 25 schematically illustrate drone movement by the conveyor belt type, and FIGS. 26 and 27 schematically illustrate a landed drone moving to an assigned hangar.

FIGS. 28 and 29 illustrate a drone parked in a hangar moving to an assigned takeoff module.

FIGS. 30 to 32 illustrate a lift unit provided with a cover according to a preferred embodiment of the present invention.

### BEST MODE

The urban drone take-off, landing, and parking system according to the present invention is a system configured in an upper space of exclusive space of a building, comprising: a landing unit formed on the rooftop floor; a take-off unit formed on an intermediate floor; a vertical movement means for raising and lowering drones while moving vertically between the landing unit and the take-off unit; a hangar unit, formed on at least one floor between the landing unit and the take-off unit, for parking and managing drones; a horizontal movement means for moving drones horizontally between the landing unit or take-off unit and the vertical movement means, and between the hangar unit and the vertical movement means; and a control unit configured to control the operation of the vertical and horizontal movement means.

### Modes of the Invention

Hereinafter, a preferred embodiment of the present invention will be described in detail with reference to the accompanying drawings.

The urban drone parking system of the present invention may be implemented in an upper space of exclusive space of a building. For example, it may be formed using the upper space of an apartment complex, commercial building, office building, or hospital.

In one embodiment, the urban drone take-off, landing, and parking system is formed in a space corresponding to the rooftop floor of the building. A vehicle parking lot may be provided in an underground space, an exclusive space of a building may be provided above the parking lot, and the urban drone landing and parking system according to the present invention may be installed above the dedicated space.

As used herein, the term “drone” refers to both unmanned drones that do not carry a person and manned passenger drones, such as Personal Air Vehicles (PAVs), capable of carrying a person.

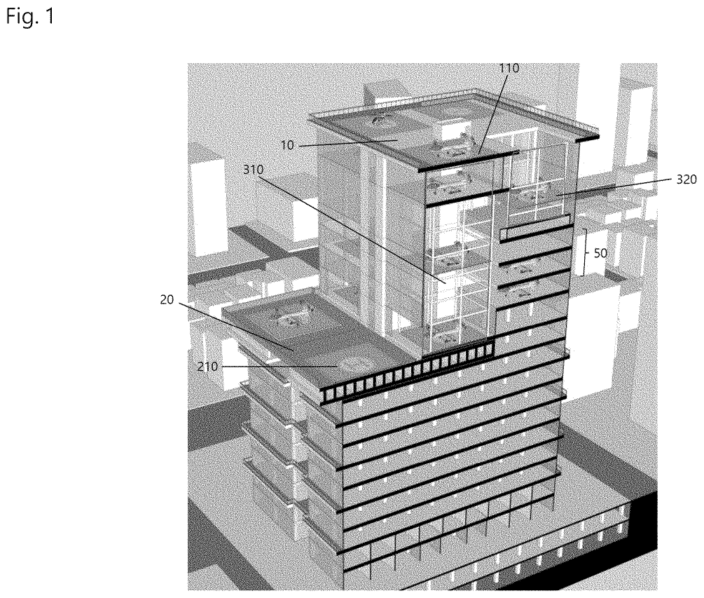

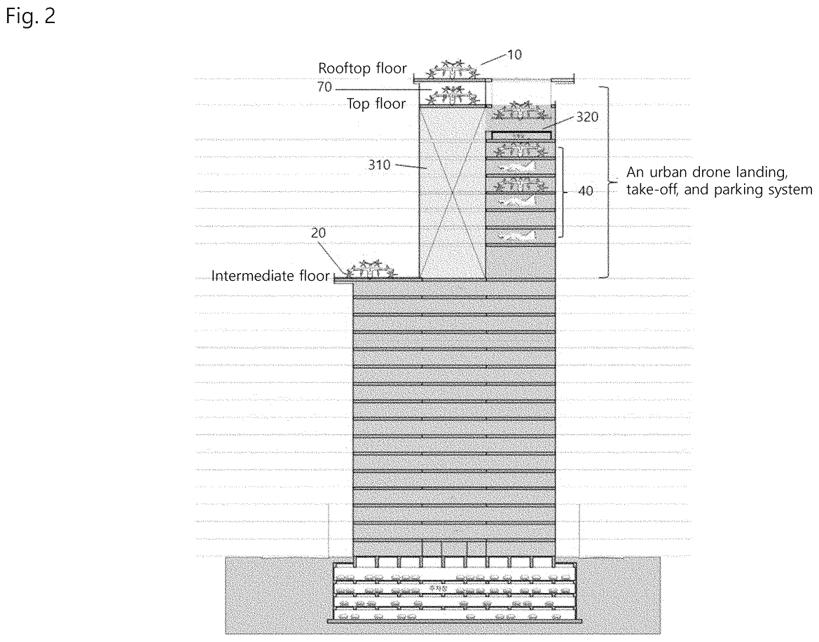

FIG. 1 is a schematic diagram illustrating the configuration of the urban drone take-off, landing, and parking system according to a preferred embodiment of the present invention, and FIGS. 2 through 4 are cross-sectional views of the system shown in FIG. 1.

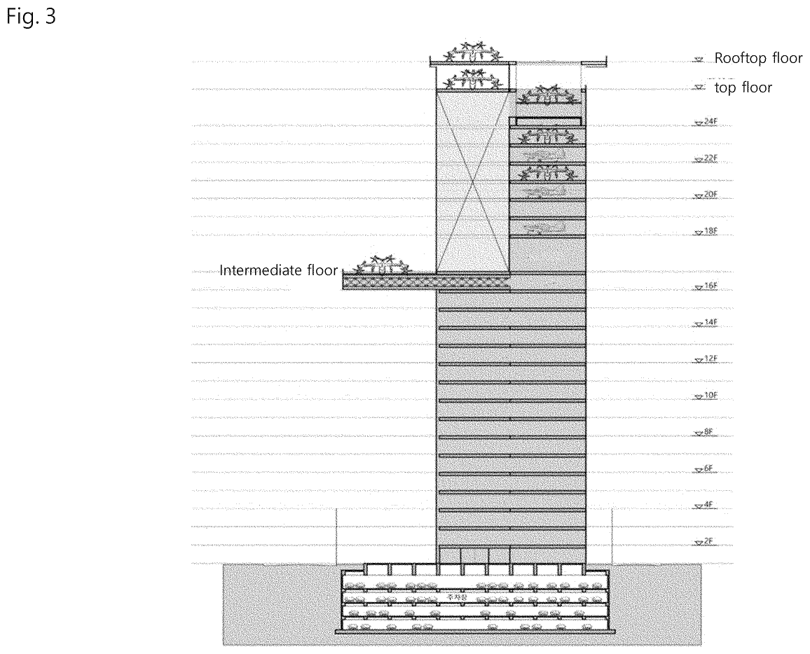

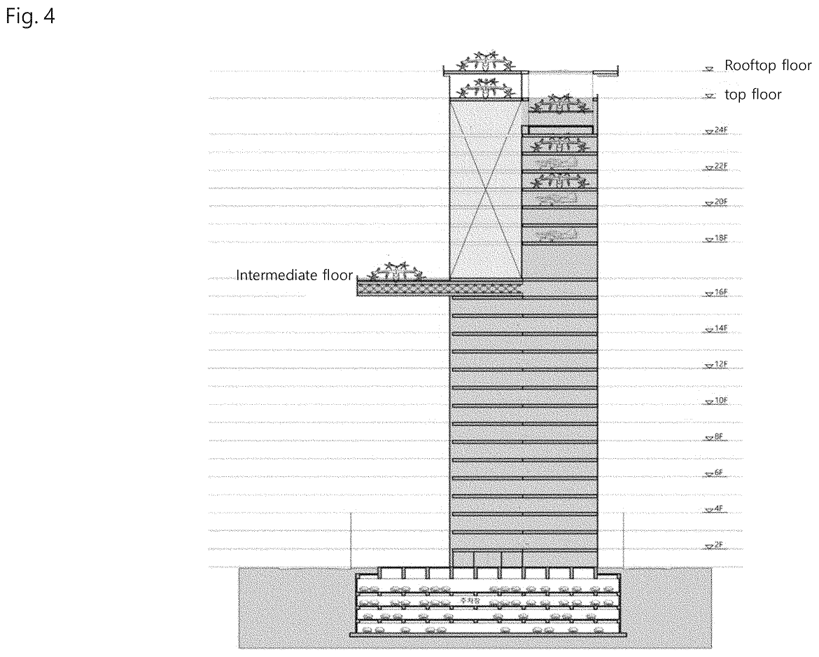

In the cross-sectional view of FIG. 2, an underground parking lot is provided for vehicles, and an exclusive space for residential or commercial use, such as offices, retail spaces, or residences, is provided on the ground floor. The urban drone take-off, landing, and parking system according to the present invention is installed above the exclusive space. FIG. 3 illustrates an embodiment where the exclusive space comprises 24 floors, and FIG. 4 illustrates an embodiment where the exclusive space comprises 15 floors.

Referring to FIGS. 1 to 4, the urban drone take-off, landing, and parking system according to the present invention may include: a landing unit (10) on the rooftop floor; a take-off unit (20) on an intermediate floor; a vertical movement means (30) for moving drones vertically between the landing and take-off units; a hangar unit (50) formed on one or more floors between the landing and take-off units for parking and managing drones; a horizontal movement means (40) for moving drones horizontally between the landing or take-off units and the vertical movement means, and between the hangar unit and the vertical movement means; and a control unit (60) for controlling the operation of the vertical and horizontal movement means.

In the present invention, since landing and take-off areas for drones located in the same space may cause safety accidents such as collisions during take-off and landing, the take-off unit and the landing unit are physically separated from each other.

Accordingly, the landing unit may be formed on the rooftop floor, and the take-off unit may be formed on an intermediate floor.

The intermediate floor may be located above the exclusive space of the building, and a vertical movement means and hangar units may be formed between the intermediate floor and the rooftop floor.

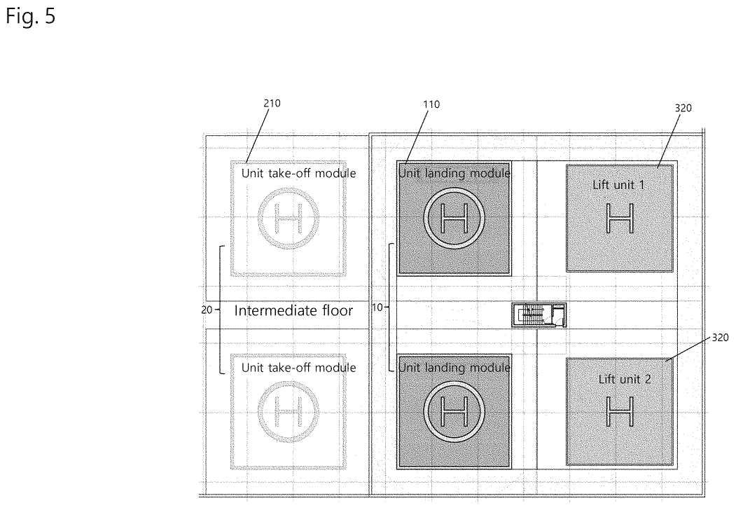

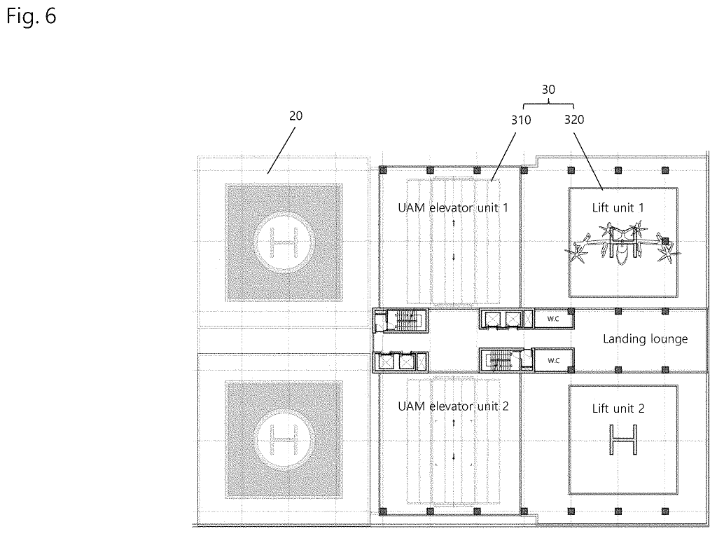

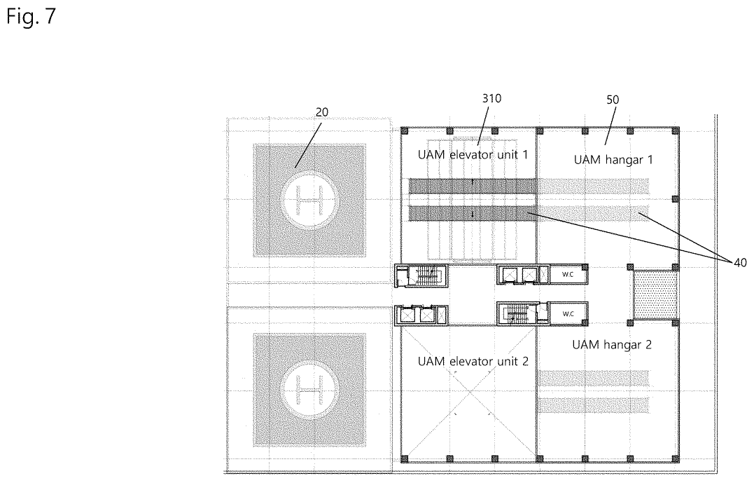

FIGS. 5 to 7 are plan views of the urban drone take-off, landing, and parking system according to a preferred embodiment of the present invention.

The landing unit (10) is formed at the center, and the take-off unit (20) is formed on an intermediate floor vertically below one side adjacent to the landing unit. A lift unit (320) of the vertical movement means is formed on the other adjacent side of the landing unit, and an elevator unit (310) may be formed below the landing unit.

The landing unit (10) may include at least one landing module (110) to which drones move for landing, and the take-off unit (20) may include at least one take-off module (210) to which drones move for take-off.

In one embodiment of the present invention, the landing unit (10) includes two landing modules (110), and the take-off unit (20) includes two take-off modules (210); however, the number of landing and take-off modules may be variably designed according to the building's floor area and number of floors.

The vertical movement means (30) may include the elevator unit (310) moving vertically between the intermediate floor with the take-off unit (20) and the top floor, and the lift unit (320) moving vertically between the top floor and the rooftop floor.

Here, the top floor is defined as the floor immediately below the rooftop floor where the vertiport (landing pad) is located.

Generally, a machine room is located above the elevator unit on the top floor. If the vertiport on the rooftop floor is formed below the machine room, the machine room may protrude above the rooftop, potentially acting as an obstacle during drone landing and causing safety issues.

Therefore, to ensure drone landing safety, the elevator unit (310) may move up to the top floor despite the machine room above the elevator unit, drones may move horizontally from the elevator unit (310) to the lift unit (320), and the lift unit (320) may move vertically from the top floor to the rooftop floor.

Since the lift unit (320) can be positioned below the machine room, even when drones are moved vertically to the rooftop floor, the machine room does not protrude above, thereby ensuring safety.

The horizontal movement means (40) is configured to move drones horizontally between the landing unit and the elevator unit, between the elevator unit and the hangar unit, between the elevator unit and the lift unit, and between the lift unit and the take-off unit.

The horizontal movement means (40) may be classified into a fixed movement type, in which rails or conveyor belts are fixedly installed on the floor or sides for driving, and an autonomous movement type, which moves using wheels.

A representative example of the fixed movement type is the conveyor belt system, which will be described below.

For drone take-off, landing, and storage, horizontal movement is required between the landing unit and the elevator unit, the elevator unit and the hangar unit, the elevator unit and the lift unit, and the lift unit and the take-off unit.

Accordingly, conveyor belt driving modules may be installed on the floor surfaces of the landing unit, elevator unit, hangar unit, lift unit, and take-off unit, and drones may be loaded onto the conveyor belts for movement.

Additionally, a waiting hangar (70) may be provided under the take-off unit (10) on the rooftop floor for temporarily parking drones that have landed.

When multiple drones arrive simultaneously, congestion may increase airborne waiting time. By providing the waiting hangar (70) as described above, landed drones can be temporarily parked, allowing other drones to land, thereby reducing landing wait times.

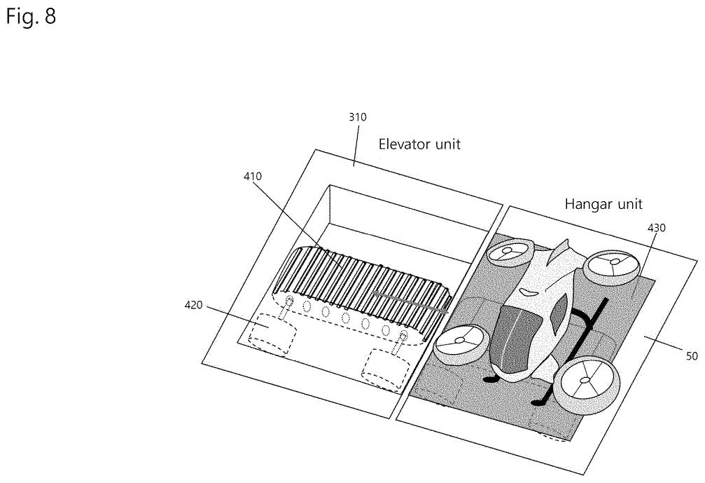

FIG. 8 schematically illustrates conveyor belt driving modules formed on the floors of the elevator unit and hangar unit according to a preferred embodiment of the present invention.

Although FIG. 8 illustrates conveyor belt driving modules on the take-off unit's modules and the lift unit floor, the same structure may also be applied between the landing unit and the elevator unit, the elevator unit and the hangar unit, and the elevator unit and the lift unit.

Referring to FIG. 8, each conveyor belt driving module may include a conveyor belt (410) with a moving stage for unidirectional movement, a drive motor (420) for driving the conveyor belt, and a motor controller (not shown) for controlling the motor's operation. The horizontal movement control module (620) of the control unit (60) may control the operation to move drones horizontally.

The conveyor belt (410) may further include a plate (430) on which drones are loaded, and the plate (430) moves horizontally according to the forward or reverse rotation of the conveyor belt (410).

Depending on the forward or reverse rotation of the conveyor belt (410), drones loaded on the plate (430) move horizontally and can be vertically moved via the lift unit (320) and the elevator unit (310).

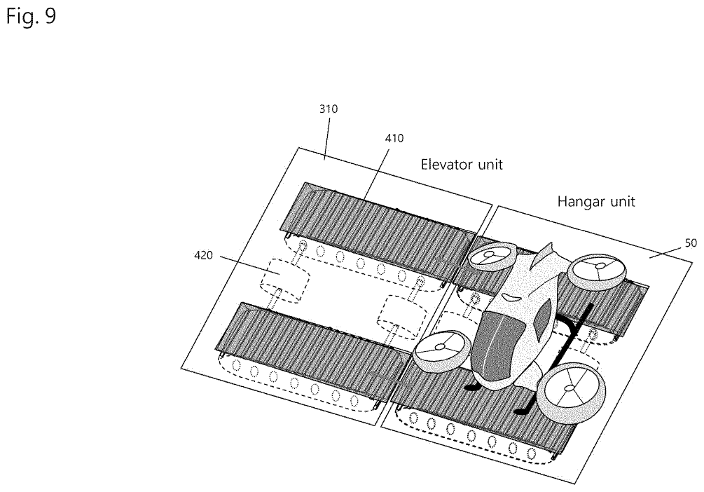

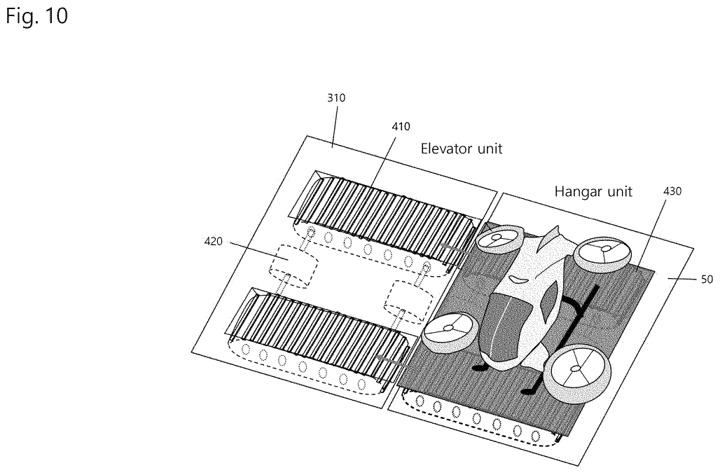

FIGS. 9 and 10 illustrate a configuration in which two conveyor belts form a single pair.

Referring to FIG. 9, when two conveyor belts are configured as a pair, the drone's support is loaded between the two conveyor belts, enabling horizontal movement of the drone without a separate plate (430). Here, when the two conveyor belts are positioned higher than the floor level, the drone's support can contact both conveyor belts during landing to be loaded.

Additionally, as shown in FIG. 10, a separate plate (430) may be arranged to mesh with the conveyor belt (410), so that the drone moves horizontally according to the forward or reverse rotation of the conveyor belt (410).

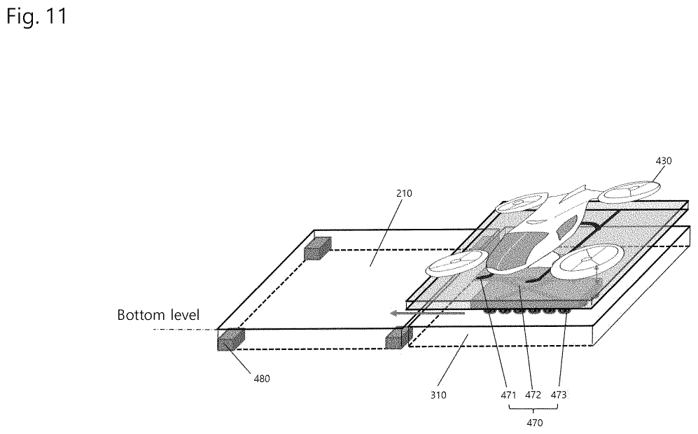

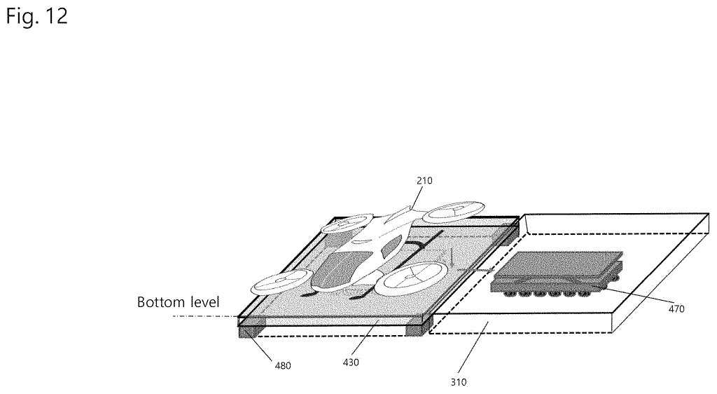

FIGS. 11 and 12 schematically illustrate horizontal movement of the horizontal movement means according to a preferred embodiment of the present invention by an autonomous movement method.

Referring to FIGS. 11 and 12, an example of horizontal movement between the elevator unit (310) and the take-off unit's take-off module (210) is described. The landing modules (110), take-off modules (210), and hangar units (50) may include plate fixing members (480) formed at the periphery.

Here, the mobile lifter (470) can horizontally move between the landing unit and the elevator unit, between the elevator unit and the hangar unit, between the elevator unit and the lift unit, and between the lift unit and the take-off unit while the plate (430) loaded with the drone is lifted.

The plate fixing member (480) serves to fix the plate (410) when it is lowered, and may protrude from the floor as a projection or band shape.

The upper portion of the plate fixing member (480) may further include a cushioning material to absorb impact and prevent damage during the loading of the plate (430). The cushioning material may be composed of elastic materials such as rubber or silicone.

The height of the plate fixing member (480) may be greater than the total height of the mobile lifter (470) when the lifting plate (471) of the mobile lifter (470) is lowered, allowing horizontal movement in the lift-down state. When the plate (430) is placed on the plate fixing member (480), its height may be the same as the floor of the corresponding layer.

The horizontal movement means may be configured to move along rails or as an autonomous mobile lifter (470) in the form of a robot.

When configured for autonomous movement, the mobile lifter (470) includes wheels (474) capable of self-movement, a lifter (472) to lift or lower the plate, a lifting plate (471) on which the plate is loaded from above the lifter, and a controller (not shown) to control wheel operation, so that the plate (430) can be lifted/lowered and autonomously moved.

When the mobile lifter (470) is configured to move along rails, the wheels (474) may travel along rails (not shown) on the floor via rollers (not shown).

The controller may include a wheel control module to control wheel operation for horizontal movement of the mobile lifter (470) and a wireless control module to receive wheel control commands for autonomous movement in real time via wireless communication and provide them to the wheel control module.

The wireless control module may receive wheel control commands from the control unit (60) and provide them to the wheel control module, thereby enabling autonomous movement of the mobile lifter (470).

The wheels may be multi-axis wheels or omni-wheels capable of movement along two axes (X-axis, Y-axis), rather than a single-axis direction. When configured as multi-axis wheels, the wheels are coupled to rotation axes that rotate according to the direction of movement, enabling two-axis movement.

The mobile lifter (470) horizontally moves the plate (430) loaded with the drone between the landing unit and the elevator unit, between the elevator unit and the hangar unit, between the elevator unit and the lift unit, and between the lift unit and the take-off unit.

A drone parked in the hangar unit (50) is lifted with the plate via the mobile lifter (470), horizontally moved into the elevator unit (310), and vertically transported to the intermediate floor where the take-off unit is located through the elevator unit (310).

After the lifted plate (430) is horizontally moved to the take-off module (210), the plate (430) is lowered and loaded onto the plate fixing member (480). Accordingly, the drone loaded on the plate is loaded onto the take-off module (210), completing take-off preparation.

Once the plate (430) is loaded onto the plate fixing member (480) as described, the mobile lifter (470) can be controlled to move drones parked in other hangar units to the take-off module (210) or to move drones that have landed on the landing module (110) to the hangar unit (50).

In the present embodiment, drones may move in contact with each other between the landing unit and the elevator unit, between the elevator unit and the hangar unit, between the elevator unit and the lift unit, and between the lift unit and the take-off unit. Alternatively, connection paths (not shown) may be formed between each of these units, allowing drones to move horizontally along the connection paths.

When the horizontal movement means (40) is of a fixed movement type, the connection path may be equipped with conveyor belts, rails, or the like, so that drones can move along the connection path.

Meanwhile, the hangar unit (50) serves as a space for parking or servicing landed drones and may be formed across multiple floors.

When parking a drone landed in the hangar unit (50), after the drone lands on a unit landing module (110) of the landing unit, the horizontal movement means (40) horizontally moves the drone to the lift unit (320). After the lift unit (320) descends, the drone is horizontally moved into the elevator unit (310), and then vertically transported by the elevator unit (310) to the floor where the designated hangar unit (50) is located. Thereafter, the drone is horizontally moved into the interior of the hangar unit (50) and parked.

When a drone parked in a specific hangar unit is to take off, the horizontal movement means (40) first horizontally moves the drone into the elevator unit, then vertically transports the drone to the intermediate floor where the take-off unit (20) is located, and finally horizontally moves the drone into a unit take-off module (210) for take-off.

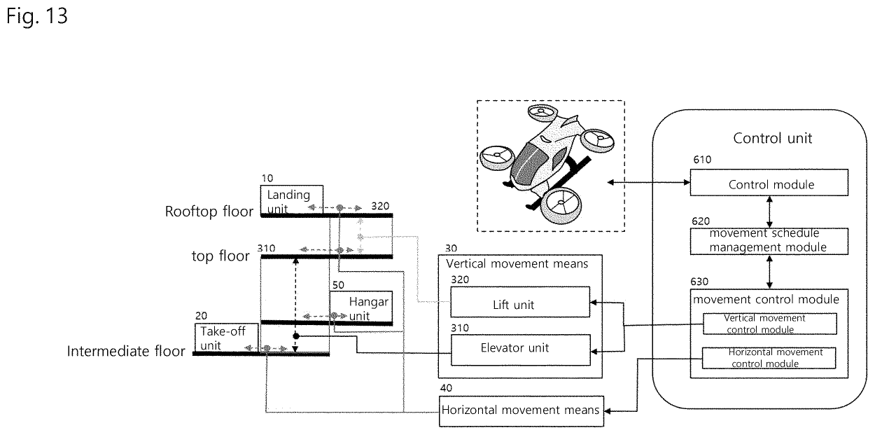

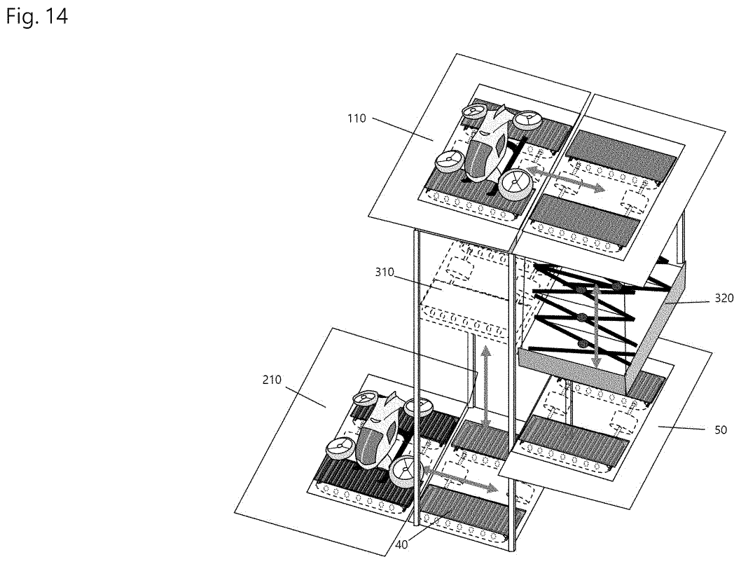

FIG. 13 is a block diagram schematically illustrating the urban drone landing, take-off, and parking system according to a preferred embodiment of the present invention.

Referring to FIG. 13, the control unit (60) may include a control module (610) for managing the landing and take-off of drones, a movement schedule management module (620) that allocates hangar units for drones landed on the landing unit, determines their movement schedule, and manages the movement schedule for drones requesting take-off, and a movement control module (630) that, according to the determined movement schedule, controls vertical and horizontal movement of drones landed on the landing unit (10) to move them to hangar units or drones parked in hangar units to move them to the take-off unit (20).

The control module (610) communicates with drones requesting landing to assign a unit landing module, controlling the drones to land on the assigned module, and communicates with drones requesting take-off to assign a unit take-off module.

The movement schedule management module (620), under the control of the control module (610), identifies drones that have landed on unit landing modules (110) of the landing unit, allocates the hangar unit (50) in which each identified drone will be parked, and determines the movement schedule for transporting the drones to the allocated hangars based on the drones' movement schedule information.

The hangar unit (50) may be installed across multiple floors and may include a common hangar shared by multiple drones and an exclusive hangar for parking specific drones. The movement schedule management module (620) can allocate a dedicated hangar if specified, or, if not specified, select one of the available common hangars to assign.

Once a hangar is allocated, the movement schedule management module (620) determines the movement schedule considering real-time movement of the vertical movement means (30) and horizontal movement means (40), and transmits the determined movement schedule information to the movement control module (630).

Upon receiving the movement schedule information, the movement control module (630) updates the existing real-time movement schedule and moves the drones to the allocated hangar according to the movement schedule.

When a drone parked in a hangar requests take-off, the movement schedule management module (620) allocates a unit take-off module considering the standby status of the take-off unit, determines a movement schedule including the order of movement with reference to other drones' movement schedules, and transmits the schedule to the movement control module (630). The movement control module (630) updates the existing real-time movement schedule and moves the drone to the allocated unit take-off module according to the schedule.

The intermediate floor where the take-off unit is installed may further include a waiting room for passengers boarding the drones. Passengers may wait in this room until the drones parked in hangars are moved to the assigned unit take-off modules.

Furthermore, when a unit take-off module is assigned and a movement schedule is determined for a drone requesting take-off, the movement schedule management module (620) may calculate the estimated waiting time for the drone to reach the assigned unit take-off module according to the schedule and transmit this information to the registered passenger terminal(phone).

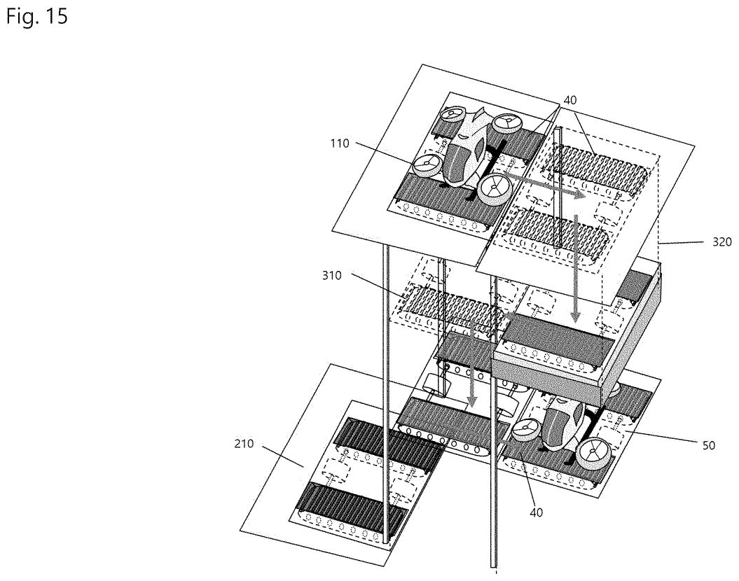

FIG. 14 schematically illustrates the movement of a drone by a conveyor belt, and FIG. 15 schematically illustrates the movement of a landed drone to its assigned hangar.

The embodiments of FIGS. 14 and 15 relate to cases in which the horizontal movement means (40) is configured as a conveyor belt type. However, it is apparent that the system may also be applied to fixed movement types such as rails, or to autonomous movement types equipped with wheels for self-mobility.

Referring to FIG. 8, when a drone lands on a unit landing module (110) under the control of the control module (610), the movement schedule management module (620) identifies the landed drone and assigns a hangar for parking.

The movement schedule management module (620) determines the movement schedule for the drone assigned to the hangar by considering the real-time movement schedules of the vertical movement means (30) and horizontal movement means (40).

More specifically, the movement schedule management module (620) generates movement schedule information for the drone by taking into account the vertical movements of the elevator unit (310) and lift unit (320) as well as the real-time movement schedule of the horizontal movement means (40), and transmits this information to the movement control module (630). The movement control module (630) updates the current schedule with the received movement schedule information and controls the movement according to the updated schedule.

Accordingly, the movement control module (630) drives the horizontal movement means (40) to move the drone landed on the unit landing module (110) horizontally, such that the drone is transported to the lift unit (320).

When the lift unit (320) descends from the rooftop floor to the top floor and the elevator unit (310) reaches the top floor, the horizontal movement means (40) is actuated to move the drone within the lift unit (320) into the interior of the elevator unit (310).

Subsequently, after the elevator unit (310) descends to the floor where the assigned hangar is located, the horizontal movement means (40) is actuated to move the drone horizontally into the hangar for parking.

The horizontal movement means (40) includes conveyor belt drive modules formed in the unit landing module (110), lift unit (320), elevator unit (310), and hangar unit (50), and the movement control module (630) sequentially controls each conveyor belt drive module so that the drone can be horizontally moved to the desired location.

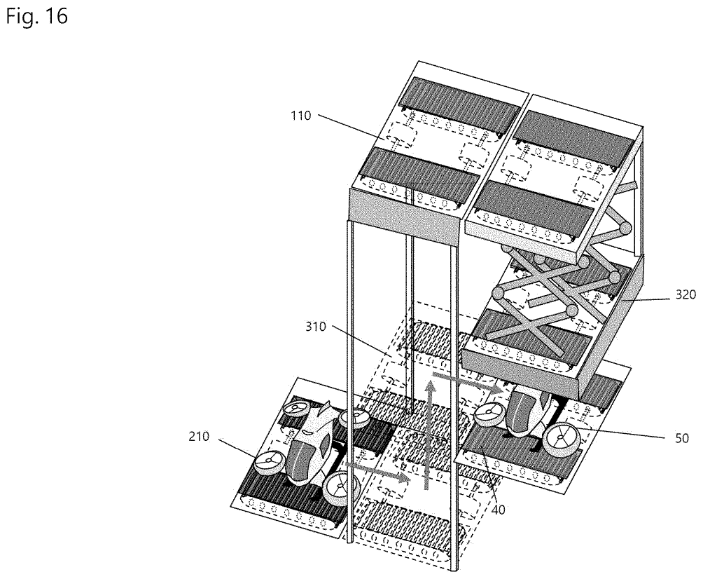

FIG. 16 schematically illustrates the movement of a drone parked in a hangar to an assigned unit take-off module.

Referring to FIG. 16, when a drone parked in a hangar requests take-off, the movement schedule management module (620) assigns a unit take-off module (210) for the drone, generates a movement schedule to move the drone to the assigned module considering the current real-time movement schedule, and transmits this information to the movement control module (630).

The landing and take-off requests can be performed via an application installed on a user terminal that has control authority over the drone, allowing the user to select menus for landing and take-off requests.

By mapping and storing the identification information of the user terminal with that of the drone, the drone can be easily identified when the user is recognized, simplifying the confirmation of request information.

According to the movement schedule information, when the elevator unit (310) moves to the floor where the assigned hangar is located, the horizontal movement means (40) is actuated to move the drone parked in the hangar unit (50) into the interior of the elevator unit (310).

Subsequently, after the elevator unit (310) descends to the intermediate floor where the take-off unit (20) is located, the horizontal movement means (40) is actuated to move the drone horizontally to the assigned unit take-off module (210).

Once the drone reaches the unit take-off module (210), the movement schedule management module (620) transmits an alert to the user terminal with control authority over the drone, notifying that the drone is ready for take-off.

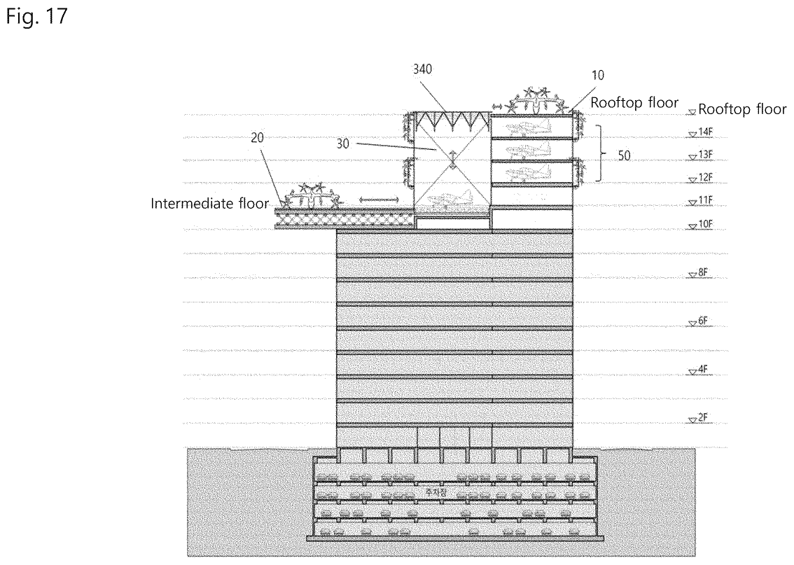

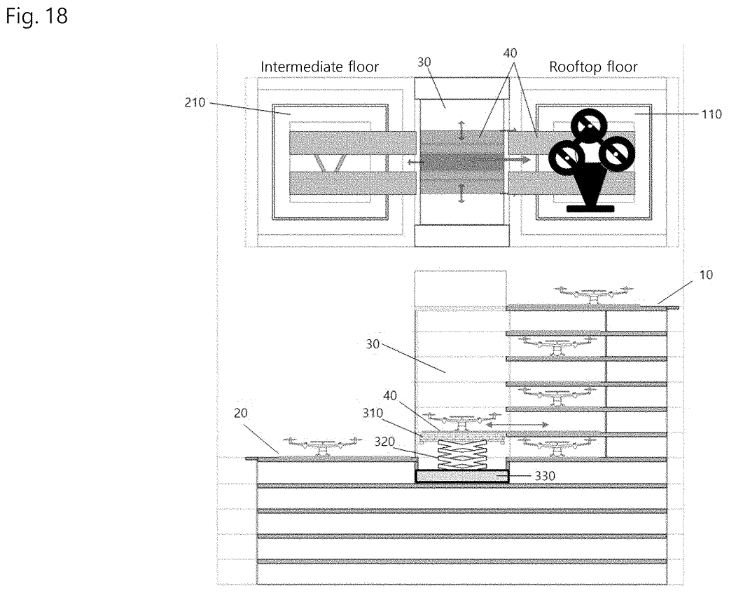

FIGS. 17 and 18 are cross-sectional views of the urban drone landing, take-off, and parking system according to another embodiment of the present invention.

In the cross-sectional views of FIGS. 17 and 18, a parking lot for automobiles is provided in the basement floors, exclusive spaces for residential or commercial facilities such as offices, retail, or housing are provided on the ground floor, and the urban drone landing, take-off, and parking system according to the present invention is applied above these exclusive spaces.

Referring to FIGS. 17 and 18, the system includes a landing unit (10) formed on the rooftop floor, a take-off unit (20) formed on the intermediate floor, a vertical movement means (30) for vertically transporting drones between the landing and take-off units, a hangar unit (50) formed on each floor between the landing and take-off units for parking and managing drones, a horizontal movement means (40) for horizontally moving drones between the landing unit or take-off unit and the vertical movement means and between the hangar unit and the vertical movement means, and a control unit (60) for controlling the operation of the vertical and horizontal movement means.

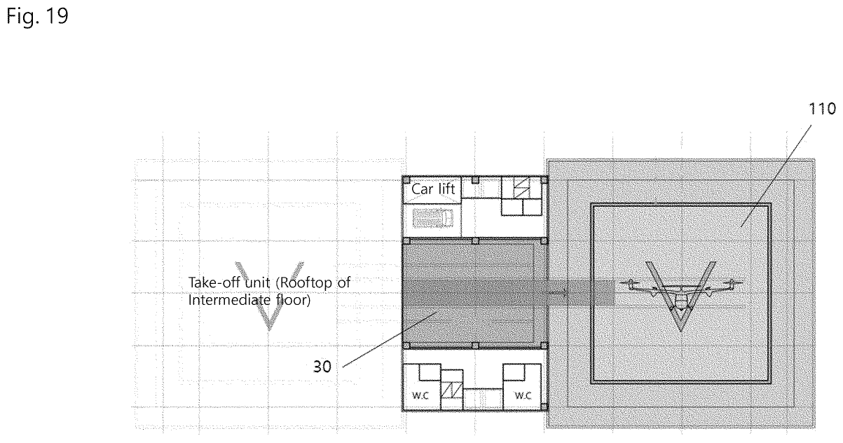

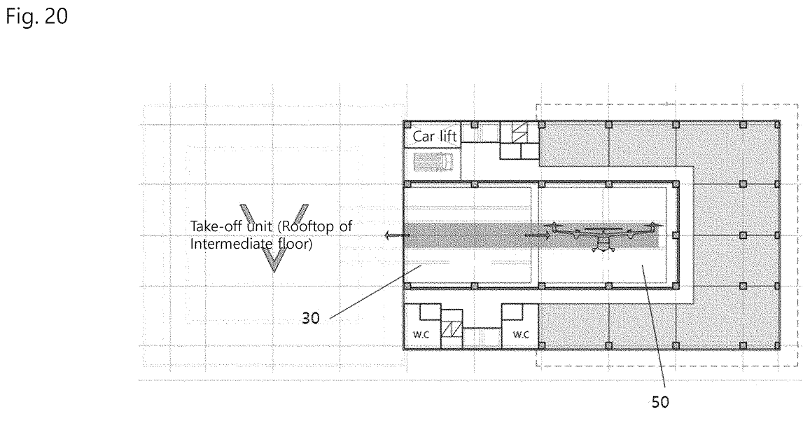

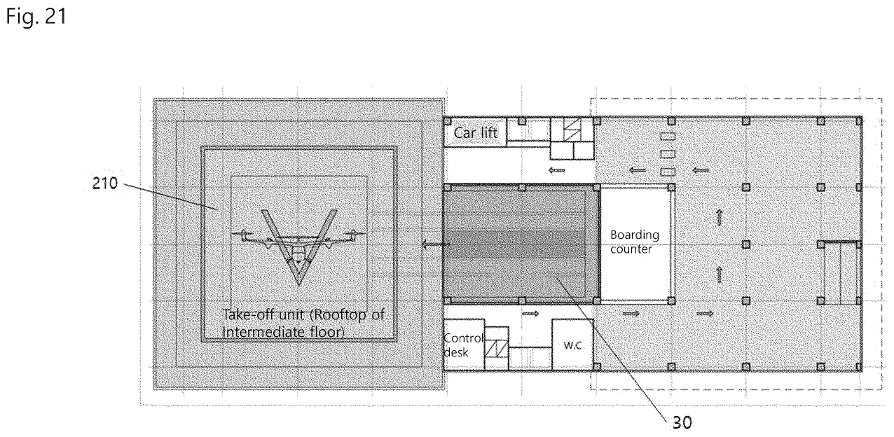

FIGS. 19 to 21 are plan views of the urban drone landing, take-off, and parking system according to a preferred embodiment of the present invention. FIG. 19 is a plan view of the rooftop floor where the landing unit is located, FIG. 20 is a plan view of the floor where the hangar unit is located, and FIG. 21 is a plan view of the intermediate floor where the take-off unit is located.

A vertical movement means (30) is formed at a central portion, a landing unit (10) is formed on one side adjacent to the vertical movement means on the rooftop floor, and the takeoff unit (20) may be formed on the other side adjacent to the vertical movement means on an intermediate floor located vertically below the rooftop floor.

The landing unit (10) may include at least one unit landing module (110) to which drones move for landing, and the take-off unit (20) may include at least one unit take-off module (210) to which drones move for take-off.

The vertical movement means (30) may be configured as a lift unit vertically moving between the intermediate floor where the take-off unit (20) is located and the top floor where the landing unit (10) is located.

In the case of a lift-type configuration, since the machine room is located below and the lifter vertically moves a fixed plate provided on the lifter, the structure can be formed such that the machine room does not protrude above the lift unlike the elevator type.

Therefore, to ensure safety when drones land, it is preferable to configure the vertical movement means (30) as a lift type that can be constructed without an upper machine room, instead of an elevator type with an exposed upper machine room.

More specifically, when the vertical movement means (30) is configured as a lift unit, it may include a loading plate (310) where the drone is loading, a lift unit (320) coupled below the loading plate for vertically moving the loading plate, and a machine room unit (330) formed below the lift unit to provide driving force for vertical movement of the lift.

The horizontal movement means (40) moves drones horizontally between the landing unit and lift unit, between the lift unit and hangar unit, and between the lift unit and take-off unit.

Since the configuration of the horizontal movement means (40) is the same as the first embodiment of FIGS. 5 to 7, detailed description is omitted.

For drone landing, take-off, and parking, horizontal movement is required between the landing unit and lift unit, between the lift unit and hangar unit, and between the lift unit and take-off unit.

Therefore, conveyor belt drive modules (41, 42, 43, 45) may be installed on the floors of the landing unit, hangar unit, lift unit, and take-off unit, and drones may be loaded and moved on these conveyor belt drive modules.

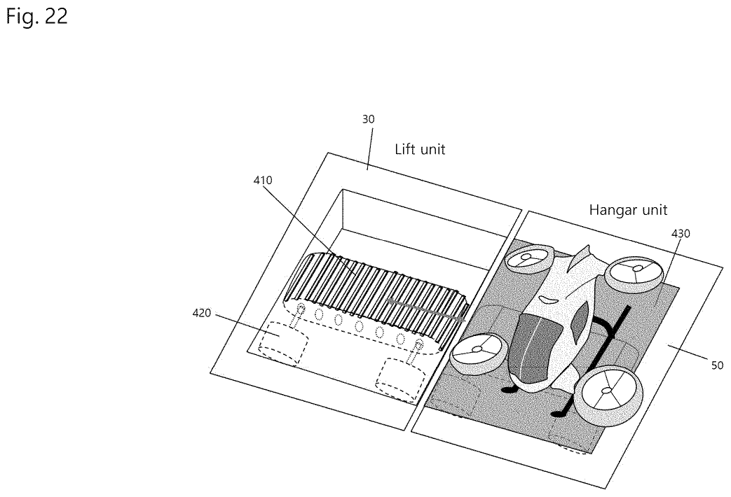

FIG. 22 schematically illustrates conveyor belt drive modules formed on the floors of the lift unit and hangar unit according to a preferred embodiment of the present invention.

FIG. 22 shows conveyor belt drive modules (42, 43) formed on the floors of the unit take-off module and lift unit, but conveyor belt drive modules (41, 45) may also be formed on the floors of the landing unit and hangar unit, respectively.

Therefore, the same structure as shown in FIG. 22 may also be applied between the landing unit and lift unit, and between the lift unit and hangar unit.

Between the landing unit and the lift unit, between the lift unit and the hangar unit, and between the lift unit and the takeoff unit, conveyor-belt driving units may be disposed in contact with one another, thereby allowing the drone to move via the conveyor-belt driving units. In addition, when a space for movement is required between the landing unit and the lift unit, between the lift unit and the hangar unit, or between the lift unit and the takeoff unit, a connecting passage (not shown) may be formed so that the drone can move horizontally through the connecting passage. In this case, conveyor-belt driving units may also be provided in each of the connecting passages.

Similarly to FIGS. 11 and 12, the horizontal movement means may move horizontally via an autonomous movement method.

In the present embodiment, although drones may move directly in contact between the landing unit and lift unit, between the lift unit and hangar unit, and between the lift unit and take-off unit, connection paths may be formed between these units to allow drones to move horizontally via the connecting passages.

When parking a drone landed in the hangar unit (50), after the drone lands on a unit landing module (110) of the landing unit, the horizontal movement means (40) moves the drone to the lift unit (30), which then descends and vertically transports the drone to the floor where the assigned hangar unit (50) is located, after which the drone is moved horizontally into the hangar for parking.

When a drone parked in a specific hangar unit is to take off, the horizontal movement means (40) moves the drone horizontally into the lift unit (30), then vertically to the intermediate floor where the take-off unit (20) is located, and then horizontally into the unit take-off module (210) for take-off.

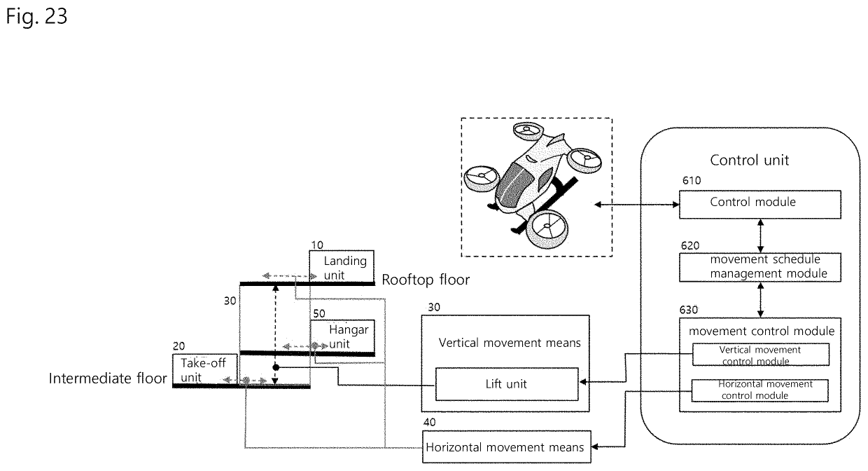

FIG. 23 is a block diagram schematically illustrating the urban drone landing, take-off, and parking system according to a preferred embodiment of the present invention.

The system of FIG. 23 is identical to the system of FIG. 13 except that the vertical movement means (30) is configured solely as a lift unit, and detailed description is omitted.

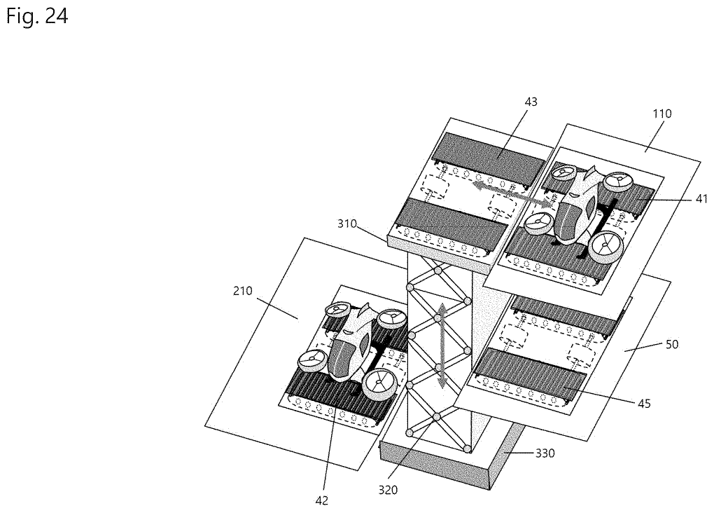

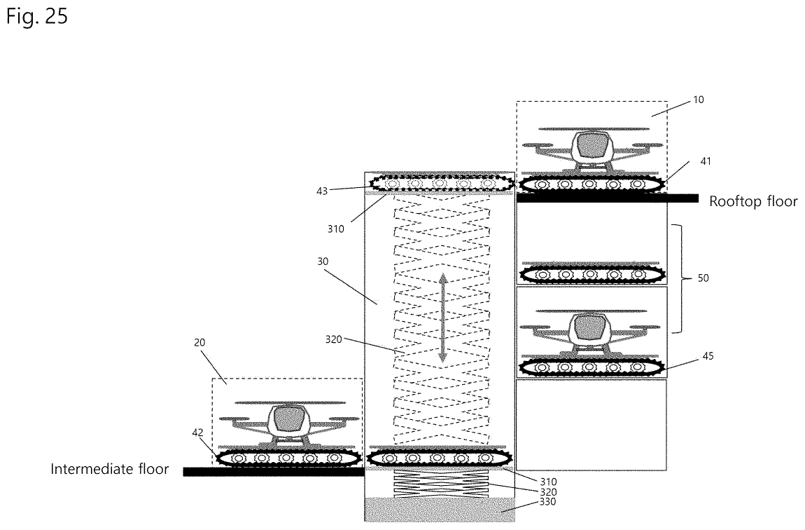

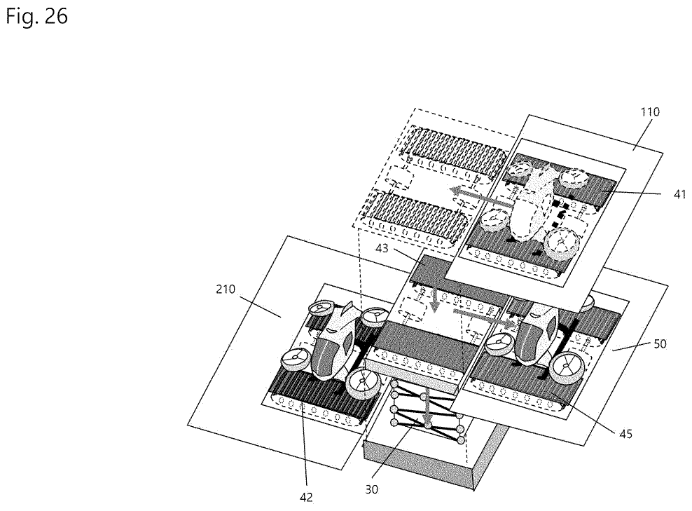

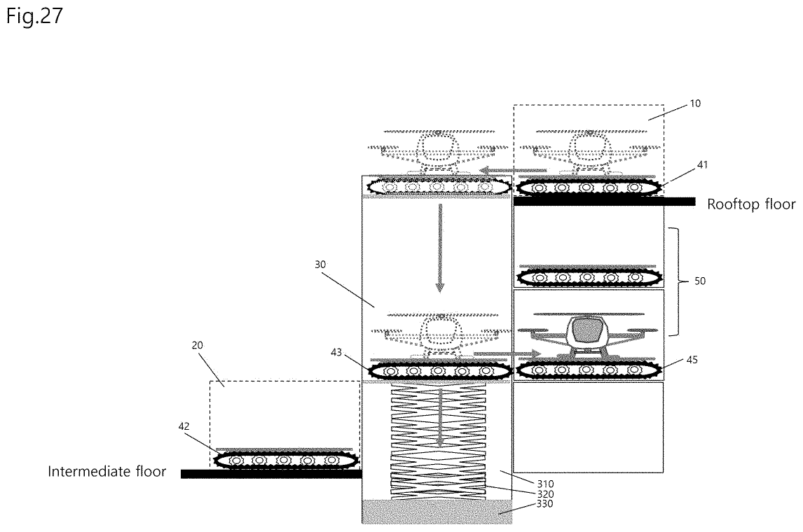

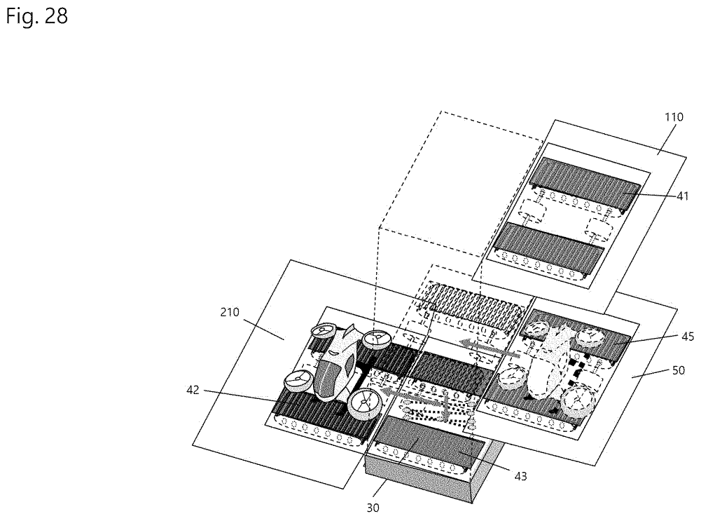

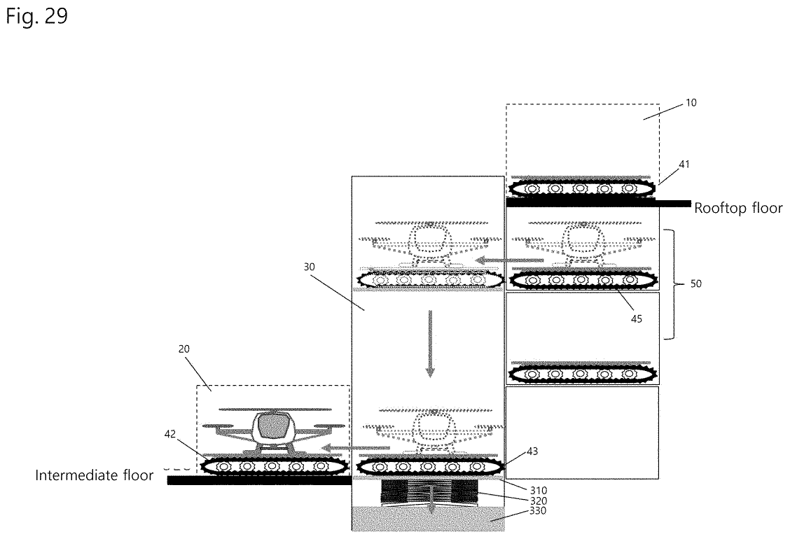

FIGS. 24 and 25 schematically illustrate movement of drones by the conveyor belt method, FIGS. 26 and 27 illustrate movement of landed drones to assigned hangar, and FIGS. 28 and 29 illustrate movement of drones parked in hangars to assigned unit take-off module.

The embodiments of FIGS. 24 to 29 relate to cases in which the horizontal movement means (40) is a conveyor belt type, but it is apparent that fixed movement types such as rails, or autonomous movement types equipped with wheels may also be applied.

Further, the embodiments of FIGS. 24 to 29 do not include an elevator unit (310), and therefore there is no movement inside or outside an elevator unit, but are otherwise identical to the embodiments of FIGS. 14 and 15.

Focusing only on the differing portions, the movement control module (630) drives the horizontal movement means (40) for the drone landed on the unit landing module (110) according to the transmitted movement schedule information, and, based on the operation of the horizontal movement means, the drone landed on the unit landing module (110) is horizontally transferred to the lift unit (320)

When the lift unit (30) moves to the rooftop floor, the drone landed on the unit landing module (110) is horizontally moved into the lift unit (30), and after the lift unit (30) descends to the floor where the assigned hangar is located, the horizontal movement means (40) moves the drone into the hangar for parking.

The horizontal movement means (40) includes conveyor belt drive modules (41, 42, 43, 45) formed in the unit landing module (110), unit take-off module (210), lift unit (30), and hangar unit (50), and the movement control module (630) sequentially controls each conveyor belt drive module to horizontally move the drone to the desired location.

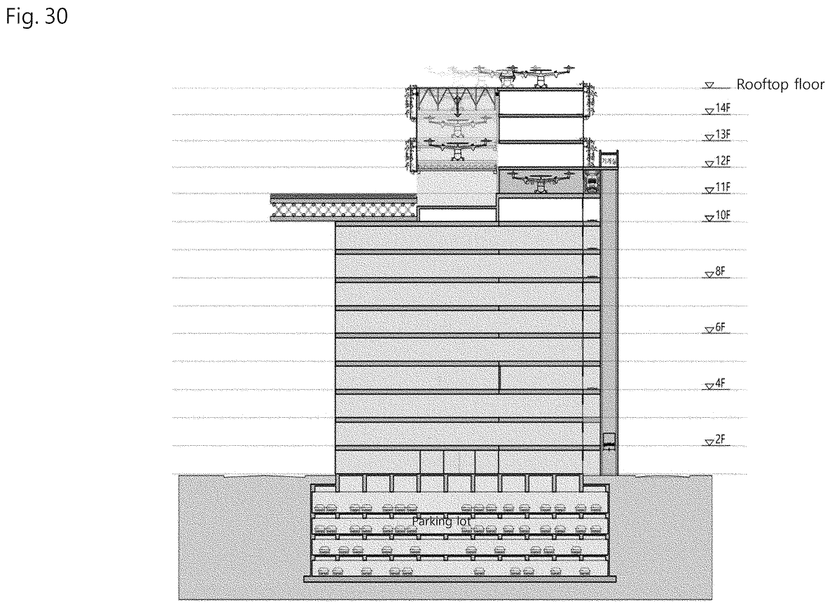

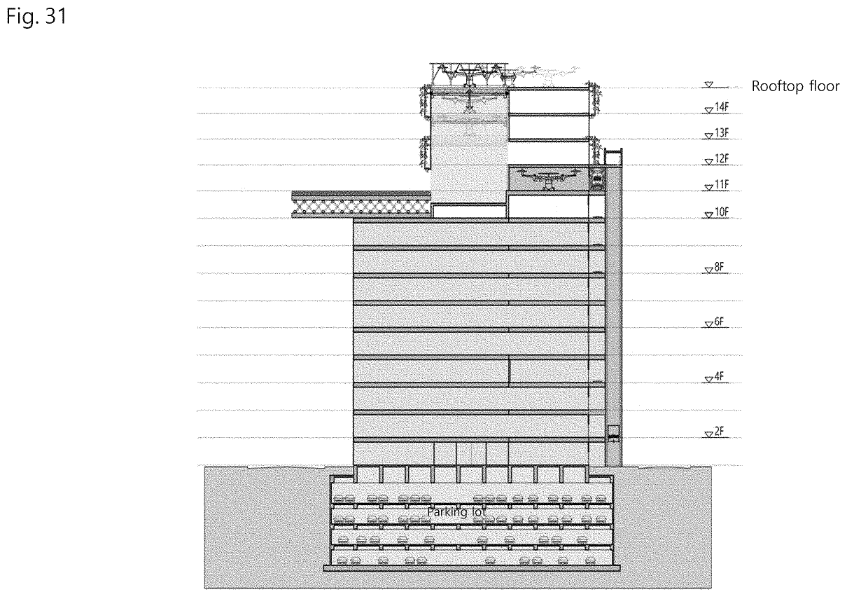

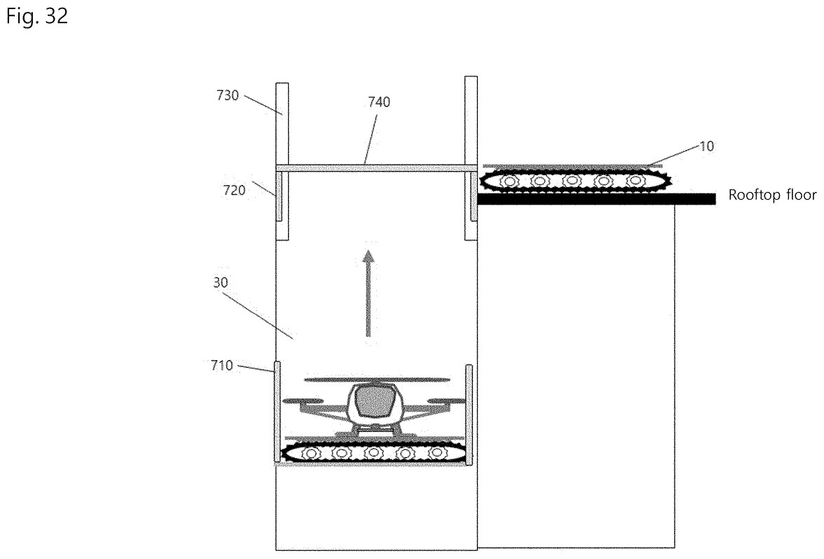

FIGS. 30 to 32 illustrate a lift unit provided with a cover according to a preferred embodiment of the present invention.

Since the lift unit (30) has no upper machine room, when the loading plate (310) of the lift unit (30) moves downward, the upper side remains open, allowing entry of snow, rain, dust, and the like.

Therefore, the cover is configured to open only when the loading plate (310) moves to the rooftop floor, and to remain closed when moving to floors below the rooftop, thereby minimizing intrusion of foreign matter from above.

Referring to FIGS. 30 to 32, the cover (740) may be formed to move vertically in a rail structure, and the cover (730) may include a moving rail (710) that moves along fixed rails (730) on both lower sides, such that guide rails (720) formed at the edges of the loading plate (310) push the moving rail (710) upward, opening the cover (730).

The cover (730) is integrally formed with the moving rail (710) and normally remains closed with the moving rail (710) mounted on the fixed rails (730), and opens only when the lift unit (30) moves to the top floor.

More specifically, as the guide rail (720) formed on the loading plate (310) of the lift unit moves upward, it comes into contact with the moving rail (710), thereby pushing the moving rail (710) upward. Consequently, the cover (730), which is integrally formed with the moving rail (710), is lifted upward and thus opened.

The moving rail (710) and guide rail (720) are formed at the peripheral area, so they do not affect horizontal movement of drones loaded on the loading plate (310), and
the cover (740) is opened only when the lift unit (30) moves to the rooftop level, and in all other cases, when the lift unit (30) moves downward, the cover (740) remains in a closed state.

### INDUSTRIAL APPLICABILITY

The present invention provides an urban drone landing, take-off, and parking system in the upper spaces of urban buildings, thereby offering landing, take-off, and parking spaces suitable for complex urban environments.

In particular, by installing a landing unit on the rooftop floor and separately installing a take-off unit on an intermediate floor, interference between landing and take-off is minimized, preventing potential safety accidents. Furthermore, by forming hangar units capable of parking multiple drones across multiple floors between the landing and take-off units, the system facilitates convenient drone landing, take-off, and parking in urban areas, making it highly useful in the construction and transportation industries.

1. An urban drone landing, take-off, and parking system formed in the upper space of exclusive space of a building, comprising:
a landing unit formed on a rooftop floor;
a take-off unit formed on an intermediate floor;
a vertical movement means for vertically transporting drones between the landing unit and the take-off unit;
a hangar unit formed on at least one floor between the landing unit and the take-off unit for parking and managing drones;
a horizontal movement means for horizontally moving drones between the landing unit or take-off unit and the vertical movement means, and between the hangar unit and the vertical movement means; and
a control unit for controlling the operation of the vertical movement means and the horizontal movement means.

2. The system of claim 1, wherein the vertical movement means comprises:
an elevator unit that moves up to the top floor due to a machine room provided above the elevator unit so as to ensure safety during drone landing; and
a lift unit which, after a drone is horizontally transferred from the elevator unit to the lift unit, moves from the top floor to the rooftop floor and has a machine room located below the lift unit,
such that the rooftop vertiport (landing unit) is ensured to be formed at a height higher than the machine room, and the machine room does not protrude above the rooftop, thereby preventing in advance any safety hazard that may occur if the machine room were to act as an obstacle during drone landing.

3. The system of claim 1, wherein the vertical movement means is only a lift unit with a machine room located at the lower part, such that the lift unit does not protrude above the rooftop vertiport and is formed at the same level as the landing unit floor.

4. The system of claim 2, wherein the horizontal movement means moves drones horizontally between the landing unit and the elevator unit, between the elevator unit and the hangar unit, between the elevator unit and the lift unit, and between the lift unit and the take-off unit; and is configured either as a fixed movement type, such as rails or conveyor belts installed on the floor or side, or as an autonomous movement type equipped with wheels.

5. The system of claim 3, wherein the horizontal movement means moves drones horizontally between the landing unit and the lift unit, between the lift unit and the hangar unit, and between the lift unit and the take-off unit; and is configured either as a fixed movement type, such as rails or conveyor belts installed on the floor or side, or as an autonomous movement type equipped with wheels.

6. The system of claim 1, wherein:
wherein the landing unit is formed on a rooftop level,
the takeoff unit is formed on an intermediate rooftop located vertically below the landing unit,
and the vertical movement means vertically transports the drone among the rooftop floor on which the landing unit is formed, the intermediate floor on which the takeoff unit is formed, and the floor on which the hangar is formed.

7. The system of claim 1, wherein the control unit comprises:
a control module for managing drone landing and take-off;
a movement schedule management module for assigning hangar units to drones landed on the landing unit, determining movement schedules, and managing movement schedules for drones requesting take-off; and
a movement control module for controlling vertical and horizontal movement of drones according to the determined movement schedules, to move drones from the landing unit to the hangar unit, or from the hangar unit to the take-off unit.
